(19) United States
(12) Patent Application Publication
(10) Pub. No.: US 2003/0011640 A1
(43) Pub. Date: Jan. 16, 2003

(54) System and methods for implementing peripheral device front menu panels

(76) Inventors: Brett A. Green, Meridian, ID (US); Larry A. Copp, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/904,604

(22) Filed: Jul. 12, 2001

(51) Int. Cl. G06F 3/14

(52) U.S. Cl. 345/810

(57) ABSTRACT

The system and methods described herein relate to creating and driving the front menu panel of a dedicated purpose device with technologies used to implement web pages. The use of HTML or other markup language documents to create menu pages for display on a touch sensitive menu screen makes the menu screen easily reconfigurable to accommodate functional upgrades to the dedicated purpose device. Script code executed behind selected menu items alters internal device settings and changes text displayed on the menu pages or refreshes the touch screen entirely with a new menu page. Altering the menu page text and corresponding internal device settings reduces the need for a large number of menu keys on the front panel by permitting a fewer number of menu keys to serve multiple purposes. Implementing front menu panels in this manner reduces costs and difficulties typically associated with maintaining and upgrading dedicated purpose devices as well as simplifies the use of such devices.

### TECHNICAL FIELD

The present invention relates to peripheral device front menu panels, and more particularly, to touch sensitive menu screens for peripheral devices that are created and driven by technologies used to implement web pages.

### BACKGROUND

Peripheral or “dedicated purpose” devices such as printers, scanners, copiers, and fax machines, or multifunction peripheral (MFP) devices that combine two or more peripheral devices into a single device, typically include a front menu panel or control panel that is manufactured for a lifetime purpose or use as part of the device. That is, once the device is manufactured, the front menu panel is a permanently fixed user interface that provides access to the functionality of the device as it exists at the time of manufacturing.

Displays for front menu panels on many peripheral devices are driven by compiled program code that is embedded in ROM (read only memory) on the device. The code is generally assembly code or “C” code that is very specialized to the particular device. Thus, front menu panel keys or buttons are usually single-function keys implemented with “hard-coded” values that are permanently set once the code is compiled or the device is manufactured.

There are various disadvantages with this type of front menu panel interface for peripheral devices. For example, the use of single-function keys can result in the need for a large number of keys on devices such as multifunction peripherals or fax machines. A large number of keys increases production costs and makes the device less competitive in the marketplace.

Another specific example involves localizing a peripheral device to a particular language. Manufacturers offer peripheral devices that can function using a growing number of languages. Typically, upon an initial software installation, a user selects the local language in which the device will display information. In addition, the device should have keys or buttons associated with the front menu panel display that are labeled using the language of choice. However, as new software makes additional languages available for use in the peripheral device, devices are manufactured with keys that are either not labeled or are labeled in languages other than the local language a user selects during the initial software installation. Thus, labeling keys in a local language on a device manufactured prior to the availability of software for that particular language typically requires a plastic screen overlay or the addition of text near the keys using, for example, a silk screen method. Both of these methods for labeling keys in the proper language add costs and can inhibit the use of the keys.

Other disadvantages with current front menu panel interfaces involve the upgradability of the peripheral device. More and more high-end peripheral devices can be functionally upgraded through the installation of new software developed by the device manufacturer or a third party software vendor. Therefore, sometime after the purchase of a device, a user may be alerted to a product upgrade that would be useful to have for the device. Such upgrades typically require some reconfiguration of the front menu panel to permit user access to the added functionality. However, difficulties in reconfiguring many peripheral device front menu panels having “hardcoded” keys can severely limit or prohibit the upgradability of the device.

In addition, even when reconfiguring the front menu panel is possible, factors such as cost and user familiarity with the device tend to discourage proceeding with such upgrades. Although the device upgrade itself may amount to little more than installing additional software, the costs associated with reconfiguring the front menu panel are generally quite high. A reconfigured front menu panel can also cause significant confusion among users who expect particular keys to perform particular functions on a given peripheral device.

Accordingly, the need exists for a peripheral device front menu panel that has selectable keys or buttons capable of multiple uses and that is easily reconfigurable to adapt to functional upgrades made to the peripheral device.

### SUMMARY

A touch sensitive menu screen on a dedicated purpose device presents menu pages defined by markup language documents such as HTML (hypertext markup language) or XML (extensible markup language) documents. Dedicated purpose devices generally include peripheral and stand-alone devices such as printers, scanners, copiers, fax machines, and multifunction peripheral (MFP) devices that combine two or more of such devices into a single device. Menu pages displayed on the touch sensitive menu screen identify and permit user access to operable functions of the dedicated purpose device through selectable menu items defined within the markup language documents. The menu pages are stored as markup language documents in a memory on the device and served to the touch sensitive menu screen by a local server module running on the device.

The selectable menu items are graphically displayed on the touch sensitive menu screen in the general form of keys or buttons that include identifying text. Because menu pages are created and driven by markup language documents, they are entirely dynamic. Thus, the layout for each menu page, including the keys, text, and other graphical information is easily configurable through the underlying markup language document. Keys and text can be made to appear in virtually any size, shape and position on the touch sensitive menu screen. In addition, new markup language documents can be added to create new menu pages that adapt the touch sensitive menu screen to display and provide access to additional or varied operable functions installed as upgrades to the dedicated purpose device.

Script code such as javascript is associated with selectable menu items and runs when a user activates a corresponding menu key on the touch sensitive screen. A virtual machine interprets and executes the script code. The virtual machine is implemented in software that runs on top of the hardware platform and operating system of the dedicated purpose device. The script code executing behind each menu key can perform various tasks such as changing the text displayed on the touch sensitive menu screen or controlling which menu page will appear next on the screen. In addition, the script code configures the device's internal settings to correspond to the currently displayed text or menu page and initiates operable functions of the device that a user selects from the touch sensitive menu screen. Altering the menu page text and corresponding internal device settings reduces the need for a large number of menu keys by permitting a fewer number of menu keys to serve multiple purposes.

Control of a dedicated purpose device is possible by direct (local) access to the device's touch sensitive menu screen or by remote access from a computer running a standard web browser. When a device is remotely accessed, the local server serves menu pages as markup language documents to the remote browser. The user interface to the device is therefore generally consistent between local and remote access because the same markup language documents are used to generate the menu pages both locally and remotely. A remote browser interprets and displays the menu page documents just as it does with typical web page documents. The remote computer can employ various input devices (e.g., a mouse) for selecting menu items from the menu pages presented by the browser. In addition to controlling the device by remotely browsing the menu pages, the menu pages themselves can be remotely configured through reformatting the underlying markup language documents and restoring the documents to the memory on the device.

In a typical embodiment, a dedicated purpose device is coupled to one or more computers through a local network and to a vendor system through a wider network such as the Internet. The dedicated device provides a service such as printing to the one or more computers and is functionally upgradeable through a software download and installation from the vendor system. Along with upgrading the functionality of the device, a software installation from the vendor system additionally upgrades the available menu pages presented by the touch sensitive screen, thereby immediately adapting the menu screen to the upgraded functionality of the device.

The touch sensitive menu screen driven by web technologies (e.g., HTML, XML, javascript) allows for easily reconfigurable menu pages having selectable keys capable of multiple uses corresponding to descriptive text.

### BRIEF DESCRIPTION OF THE DRAWINGS

The same reference numbers are used throughout the drawings to reference like components and features.

FIG. 1 illustrates a dedicated purpose device in a system environment suitable for providing local and remote access to a touch sensitive menu screen on the dedicated purpose device.

FIG. 2 illustrates stand-alone dedicated purpose devices that provide local access to a touch sensitive menu screen.

FIG. 3 is a block diagram illustrating a dedicated purpose device in a system such as that shown in FIG. 1.

FIG. 4 illustrates an example of an initial menu page that might be displayed on a touch sensitive menu screen of a dedicated purpose device.

FIGS. 5, 6 and 7 each illustrate an example of a sequence of menu pages that might be displayed on a touch sensitive menu screen of the dedicated purpose device of FIG. 3 embodied as a printer.

FIG. 8 is a block diagram illustrating an alternate embodiment of a dedicated purpose device in a system such as that shown in FIG. 1.

FIGS. 9, 10, 11 and 12 each illustrate an example of a sequence of menu pages that might be displayed on a touch sensitive menu screen of the dedicated purpose device of FIG. 8 embodied as a printer.

FIG. 13 is a block diagram illustrating a stand-alone dedicated purpose device such as that shown in FIG. 2.

FIG. 14 is a block diagram illustrating an alternate embodiment of a standalone dedicated purpose device such as that shown in FIG. 2.

FIG. 15 illustrates an example of a sequence of menu pages that might be displayed on a touch sensitive menu screen of the stand-alone dedicated purpose device of FIG. 13 embodied as a copier.

FIG. 16 illustrates an example of a sequence of menu pages that might be displayed on a touch sensitive menu screen of the stand-alone dedicated purpose device of FIG. 14 embodied as a copier.

FIG. 17 is a flow diagram illustrating an example method of displaying and activating a menu page on a touch sensitive menu screen of a dedicated purpose device.

FIG. 18 is a flow diagram illustrating an example method of displaying and activating a menu page of a dedicated purpose device on a remote computer.

FIG. 19 is a flow diagram illustrating an example method of reconfiguring a touch sensitive menu screen of a dedicated purpose device to accommodate a functional upgrade to the dedicated purpose device.

### DETAILED DESCRIPTION

The system and methods described herein relate to creating and driving the front menu panel of a dedicated purpose device with technologies used to implement web pages. The use of HTML or other markup language documents to create menu pages for display on a touch sensitive menu screen makes the menu screen easily reconfigurable to accommodate functional upgrades to the dedicated purpose device. Script code executed behind selected menu items alters internal device settings and changes text displayed on the menu pages or refreshes the touch screen entirely with a new menu page. Altering the menu page text and corresponding internal device settings reduces the need for a large number of menu keys on the front panel by permitting a fewer number of menu keys to serve multiple purposes. Implementing front menu panels in this manner reduces costs and difficulties typically associated with maintaining and upgrading dedicated purpose devices as well as simplifies the use of such devices.

Exemplary System for Implementing a Touch Sensitive Menu Screen

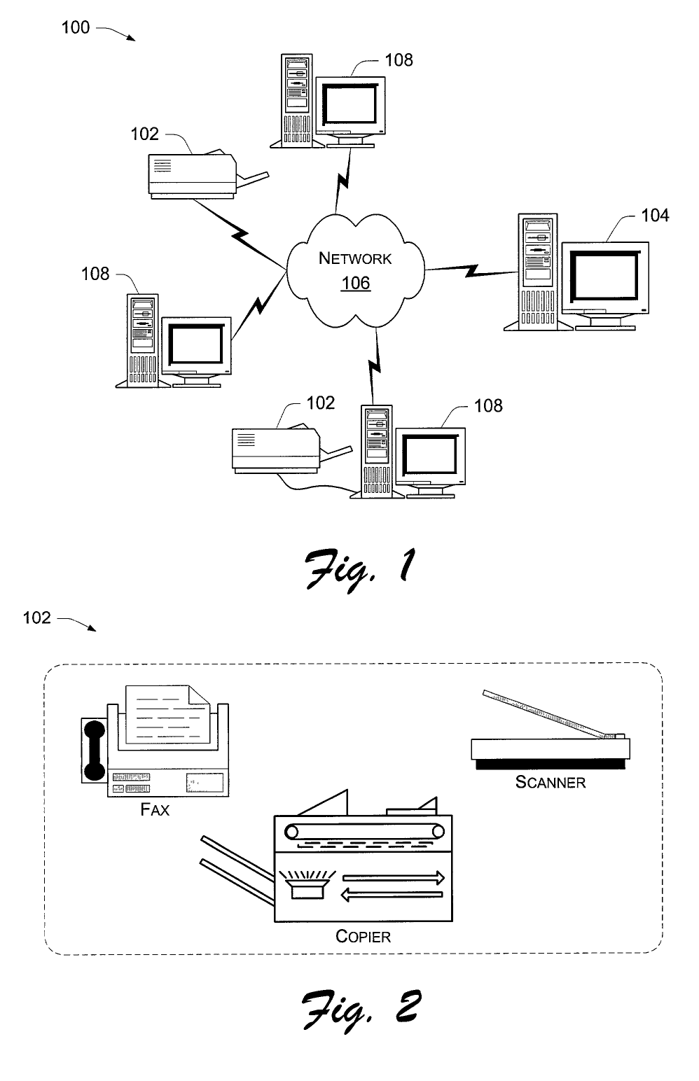

FIG. 1 illustrates an example of a system environment 100 suitable for implementing a touch sensitive menu screen driven by web page technologies that is configured to control a dedicated purpose device 102. The system environment 100 contemplates both local and remote access to a touch sensitive menu screen on a dedicated purpose device 102.

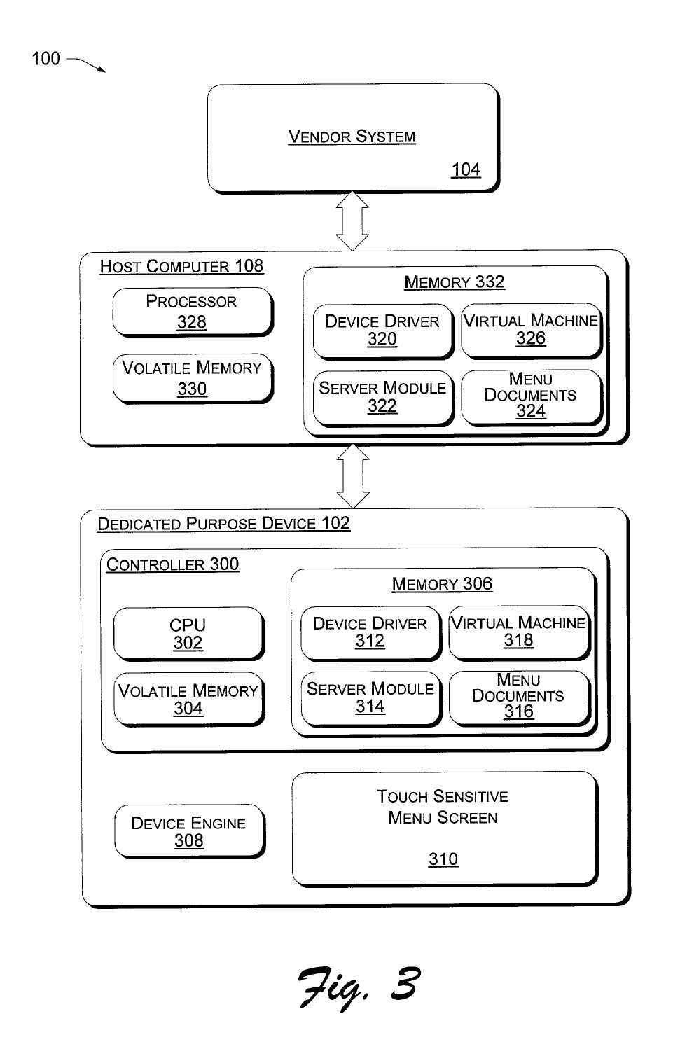

Dedicated purpose devices 102 generally include peripheral devices and stand-alone devices. Peripheral devices include devices such as printers, scanners, copiers, and fax machines, or multifunction peripheral (MFP) devices that combine two or more peripheral devices into a single device. Stand-alone devices include certain peripheral devices that often function while uncoupled or isolated from other devices. Stand-alone devices 102 therefore include devices such as copiers, scanners and fax machines like those shown in FIG. 2.

Dedicated purpose devices 102 are generally distinguishable from devices such as laptop PCs (personal computers) and pocket PCs by their limited purpose and limited user interface or input/output capabilities. For example, a typical user interface for a dedicated purpose device 102 includes a front menu panel with limited screen space and a limited number of buttons. In addition, a dedicated purpose device 102 is typically oriented toward performing one general task such as printing or copying. By contrast, devices such as laptop and pocket PCs often provide multiple and varied means of input/output such as a full screen display, a QWERTY keyboard, a trackball mouse, speakers, microphones, PCMCIA (Personal Computer Memory Card International Association) slots, portable media drives and the like. These devices are capable of performing multiple functions through executing various software applications such as word processing applications, spreadsheet applications, financial applications, network browsers and network messaging applications.

The system 100 of FIG. 1 includes dedicated purpose device(s) 102 as peripheral devices coupled to a vendor system 104 through a network connection 106. Device(s) 102 are also typically coupled to host computer(s) 108 either through a direct or network connection. Network connections 106 can include LANs (local area networks), WANs (wide area networks), an intranet, the Internet, or any other suitable communication link.

In general, the host computer 108 outputs host data to a dedicated purpose device 102 in a driver format suitable for the device 102, such as PCL or postscript for a printer device 102. A printer device 102 converts the host data and outputs it onto an appropriate print media, such as paper, transparencies or glossy photo paper.

The vendor system 104 can download software for initial installation onto the device 102 in addition to downloading software upgrades that become available for future installation. The vendor system 104 can include any software provider such as the original device manufacturer or a third party software vendor.

Exemplary Embodiment of a System for Implementing a Touch Sensitive Menu Screen

FIG. 3 illustrates an embodiment of the system 100 of FIG. 1 in greater detail. The peripheral or dedicated purpose device 102 has a controller 300 that processes the host computer 108 data. The controller 300 typically includes a data processing unit or CPU 302, a volatile memory 304 (i.e., RAM), and a non-volatile memory 306 (e.g., ROM, Flash). Dedicated purpose device 102 also includes a device engine 308 and a touch sensitive menu screen 310. The touch sensitive menu screen 310 acts as a local user interface for device 102 by displaying menu pages and accepting user input based on selectable menu items displayed on the menu pages.

The device controller 300 processes host data and manages device functions by controlling the device engine 308 and responding to input from touch sensitive menu screen 310. Controller 300 includes device driver software 312 stored in memory 306 and executed on CPU(s) 302. Memory 306 also includes a server module 314 configured to serve menu documents 316 to the touch sensitive menu screen 310. The server module 314 is a local server in the sense that it is present within the same device 102 to which it serves menu documents 316. Menu documents 316 are formatted as markup language documents using markup languages such as HTML (hypertext markup language) and XML (extensible markup language). The menu documents 316 are interpreted by the server module 314 and are configured to display textual and graphical information as menu pages on the touch sensitive menu screen 310.

Within system 100 of FIG. 1, the dedicated purpose device 102 is also accessible remotely by host computer(s) 108 executing a browser application. Thus, the server module 314 acts as a remote server that serves markup language (menu) documents 316 to host computer(s) 108. When serving a remote computer, the server module 314 does not interpret the markup language documents 316 for display prior to serving them as it does when serving the local touch sensitive menu screen 310. This is because the browser itself, executing on the remote computer is capable of interpreting the markup language documents 316 for display on the remote computer.

Graphical keys or buttons presented on menu pages by the touch sensitive menu screen 310 (or remote computer 108 display screen) offer selectable menu items that are described by accompanying textual information. Menu documents 316 driving the menu pages include embedded script code associated with graphical keys. Selecting a menu item by pressing a graphical key on the touch sensitive menu screen 310 (or clicking a graphical key on a remote computer 108 display screen using a mouse or other input device) triggers an event which causes a “virtual machine” 318 to interpret and execute the script code associated with the selected graphical key. The virtual machine 318 is a software module stored in memory 306 that executes on CPU(s) 302 to interpret and execute script code. The script code is preferably written in JavaScript code that is interpreted and executed on a Java Virtual Machine (JVM) 318. However, the script code can also be written in other script code languages such as VBScript or Perl.

The script code associated with selectable menu items (i.e., graphical keys or buttons) is configured to perform tasks that are consistent with textual information currently displayed on the menu page of the touch sensitive menu screen 310 (or remote computer 108 screen). Thus, selecting (i.e., pressing or clicking) a key labeled “menu”, may trigger the execution of script code that steps the displayed text through to the next available menu item. In this case, the currently displayed keys and their labels would remain unchanged while only the text that generally describes the menu page would change.

The script code executed behind a particular menu item may also refresh the touch sensitive menu screen 310 with a completely new menu page having different keys, different text, and an entirely new look and feel. The menu page would be driven by a different underlying markup language document from the menu documents 316 stored in memory 306 served up to the menu screen 310 by the server module 314. Just as a browser application executing on a networked computer can move from one HTML document at one URL (uniform resource locator) to another HTML document at another URL, the script code executing behind graphical keys on the touch sensitive menu screen 310 can refresh the screen 310 with new menu pages supported by new underlying markup language documents.

In addition to stepping through the menu items or completely updating the displayed menu page, the script code is also configured to reconfigure the internal settings of the device 102 to be consistent with the currently displayed menu choices and to initiate functions of the device 102 selected from the touch sensitive menu screen 310.

Although the device driver 312, server module 314, menu documents 316 and virtual machine 318 are generally stored and executed on the dedicated purpose device 102, they may also be stored and executed on host computer 108 as illustrated by device driver 320, server module 322, menu documents 324 and virtual machine 326 of FIG. 3. Under such circumstances, the server module 322 on host computer 108 acts as a remote server to the dedicated purpose device 102, serving menu documents 324 for display on the touch sensitive menu screen 310.

The host computer 108 includes a processor 328, a volatile memory 330 (i.e., RAM), and a non-volatile memory 332 (e.g., ROM, hard disk, floppy disk, CD-ROM, etc.). The host computer 108 may be implemented, for example, as a general-purpose computer, such as a desktop personal computer, a laptop, a server, and the like. The host computer 108 may implement one or more software-based device drivers 320 that are stored in non-volatile memory 332 and executed on the processor 328 to configure data into an appropriate format (e.g., PCL, postscript, etc.) and output the formatted data to the dedicated purpose device 102.

FIGS. 4, 5, 6 and 7 illustrate example menu pages that might be displayed on the touch sensitive menu screen 310 of the dedicated purpose device 102 of FIG. 3. The menu pages of FIGS. 4, 5, 6 and 7 are driven by underlying markup language documents that include embedded script code associated with various selectable menu keys.

FIG. 4 illustrates an example of an initial menu page 400. The menu page 400 includes a menu key 402, an item key 404, plus (+) and minus (−) keys 406 and a select key 408. It is noted that menu page 400 and other menu pages illustrated and described herein are provided by way of example only, and that the actual appearance and configuration of menu pages displayed on a touch sensitive menu screen 310 may vary significantly by virtue of their underlying markup language documents. A consistency of appearance between different menu pages displayed on a touch sensitive menu screen 310 contributes to user familiarity and the ease of use of the device 102. However, the appearance and configuration of any menu page is limited only by the imagination of the menu page designer and the need to present a user with functional aspects of the dedicated purpose device 102. Thus, menu pages may vary in appearance and design in a manner similar to that of web pages accessible on the Internet.

To begin stepping through the available menu items for a dedicated purpose device 102 using the example menu page 400 of FIG. 4, a user presses the menu key 402 on the touch sensitive menu screen 310. Each time the menu key 402 is pressed, script code associated with the menu key 402 executes to alter the text above the keys to indicate which menu item is currently available. Thus, pressing the menu key 402 a first time will change the currently displayed text, “00 Ready”, into text that corresponds to an available menu item describing a functional aspect of the device 102. Alternatively, each time the menu key 402 is pressed, the touch sensitive menu screen 310 might be updated with an entirely new menu page providing additional selectable items and text indicating how a user is to proceed.

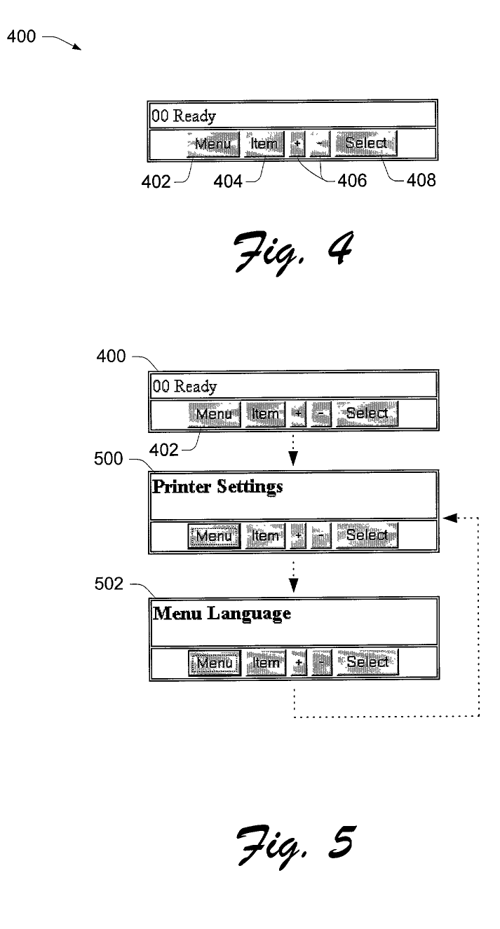

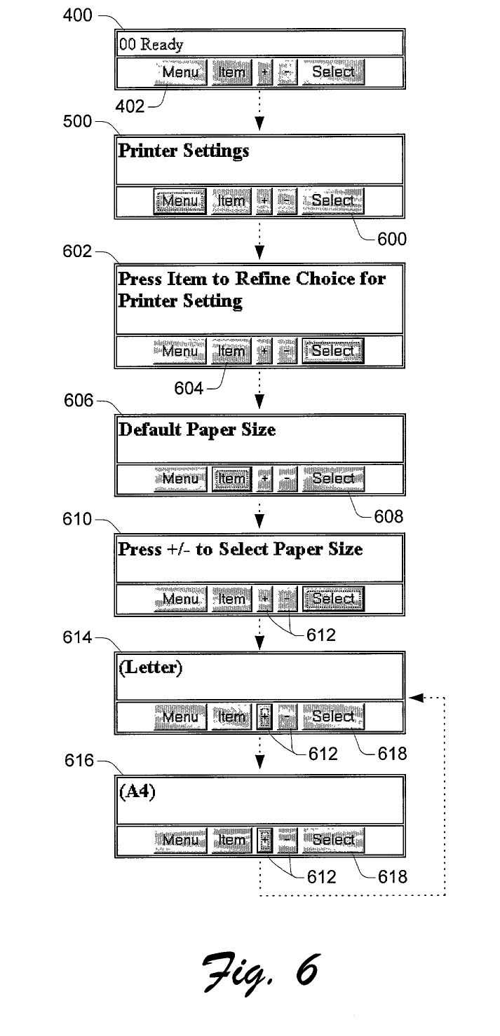

FIG. 5 illustrates an example sequence of menu pages as they might appear while stepping through menu items using the menu key 402 from menu page 400. The example menu pages of FIG. 5 present menu items for a dedicated purpose device 102 that is embodied as a printer. The touch sensitive menu screen 310 for the example printer device 102 offers a user the choices of a “Printer Settings” menu item 500 and a “Menu Language” menu item 502. Repeatedly pressing the menu key 402 on a currently displayed menu page will cycle the touch sensitive menu screen 310 through the available menu choices as indicated by the arrows between the “Printer Settings” menu page 500 and the “Menu Language” menu page 502.

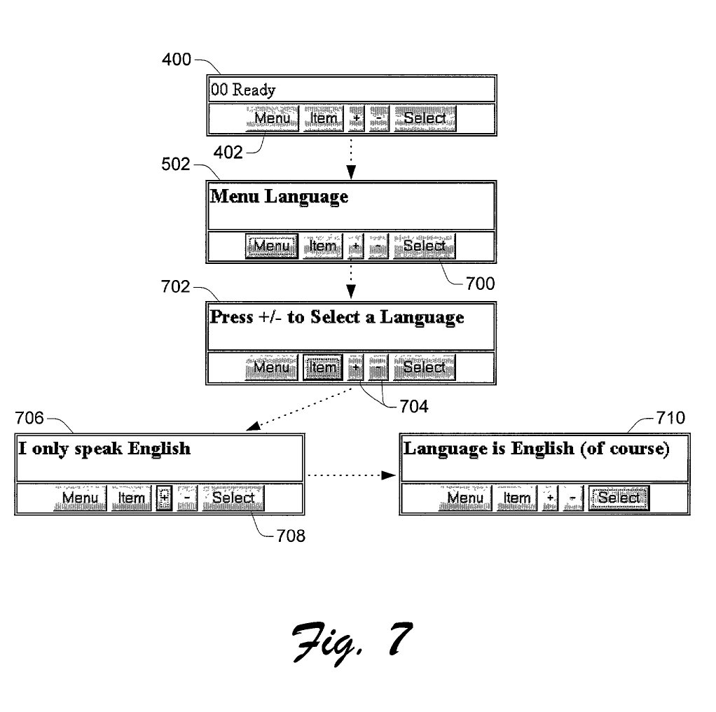

FIG. 6 illustrates an example of a sequence of menu pages as they might appear after a user activates the select key 600 from the “Printer Settings” menu item 500. Menu page 602 appears on the touch sensitive menu screen 310 in response to selecting 600 menu item 500 and provides further instructions to the user to refine the printer setting choice by pressing item key 604. Repeatedly pressing the item key 604 will present the available printer settings on the touch sensitive menu screen 310 by changing the descriptive text on the menu page or by displaying an entirely new menu page. Thus, menu page 606 appears next in the sequence, indicating a “Default Paper Size” printer setting. Because the “Default Paper Size” is the only printer setting available on the example printer device 102 of the current embodiment, it is the only setting to be displayed when the item key 604 of menu page 602 is activated. Other example printer device 102 settings are illustrated herein below in an alternate embodiment.

Upon selecting the “Default Paper Size” 606 setting using select key 608, menu page 610 is displayed, providing further instructions to the user to press the “+/−” keys 612 to select a paper size. Repeatedly pressing the “+/−” keys 612 cycles the touch sensitive menu screen 310 through the available paper sizes as indicated by the arrows between the “(Letter)” menu page 614 and the “(A4)” menu page 616. As discussed above, the descriptive text on the menu pages is updated by script code associated with the “+/−” keys 612 that executes when the keys are activated. The printer setting for the default paper size is set when the user activates one of the select keys 618.

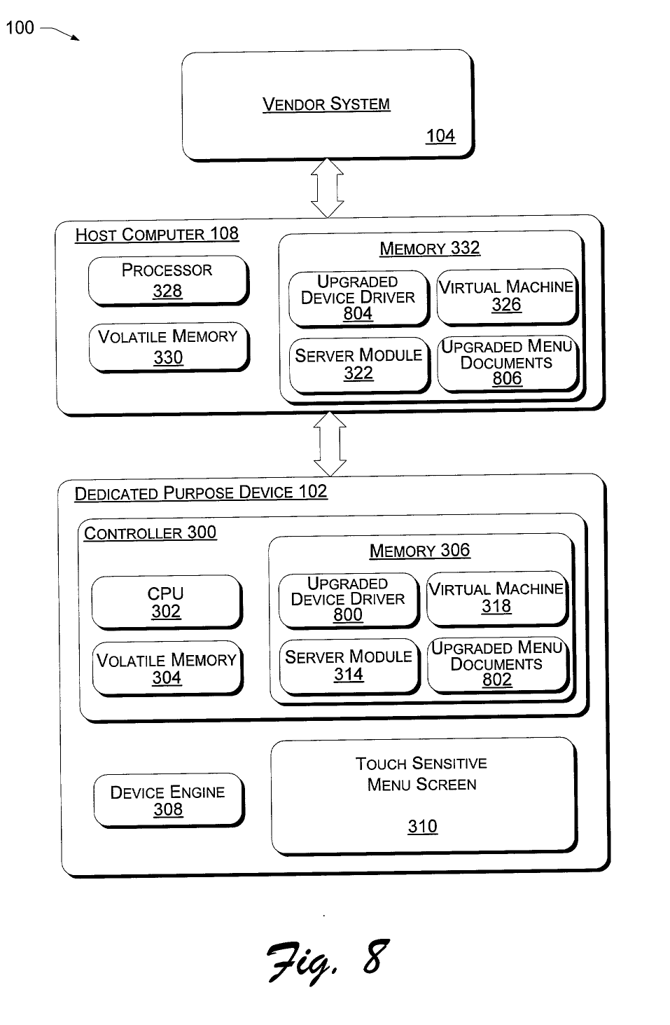

FIG. 7 illustrates an example of a sequence of menu pages as they might appear if a user activates the select key 700 from the “Menu Language” menu page 502 from FIG. 5. The process is similar to that described above with respect to the “Printer Settings” menu item 500 of FIG. 6. Thus, menu page 702 appears on the touch sensitive menu screen 310 in response to selecting 700 menu item 502, providing further instructions to the user to press the “+/−” keys 612 to select a language. Repeatedly pressing the “+/−” keys 704 will cycle the touch sensitive menu screen 310 through the available menu languages. Because English is the only menu language available on the example printer device 102 of the current embodiment, menu page 706 with the text “I only speak English” is the only menu page displayed by pressing the “+/−” keys 704. Menu page 710 confirms that the English language has been selected with the select key 708.

Alternate Embodiment of an Exemplary System for Implementing a Touch Sensitive Menu Screen

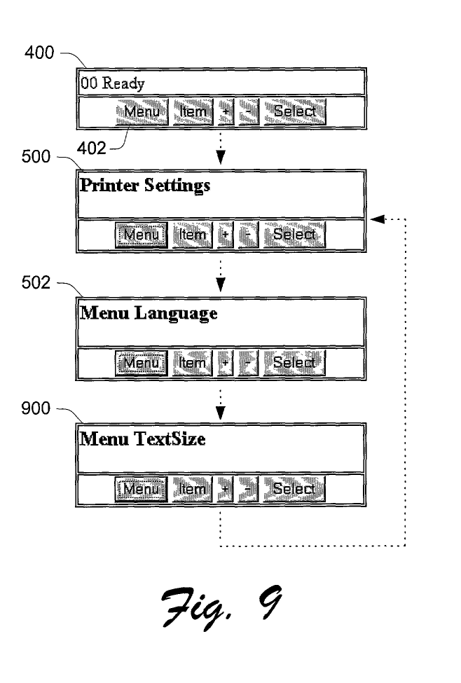

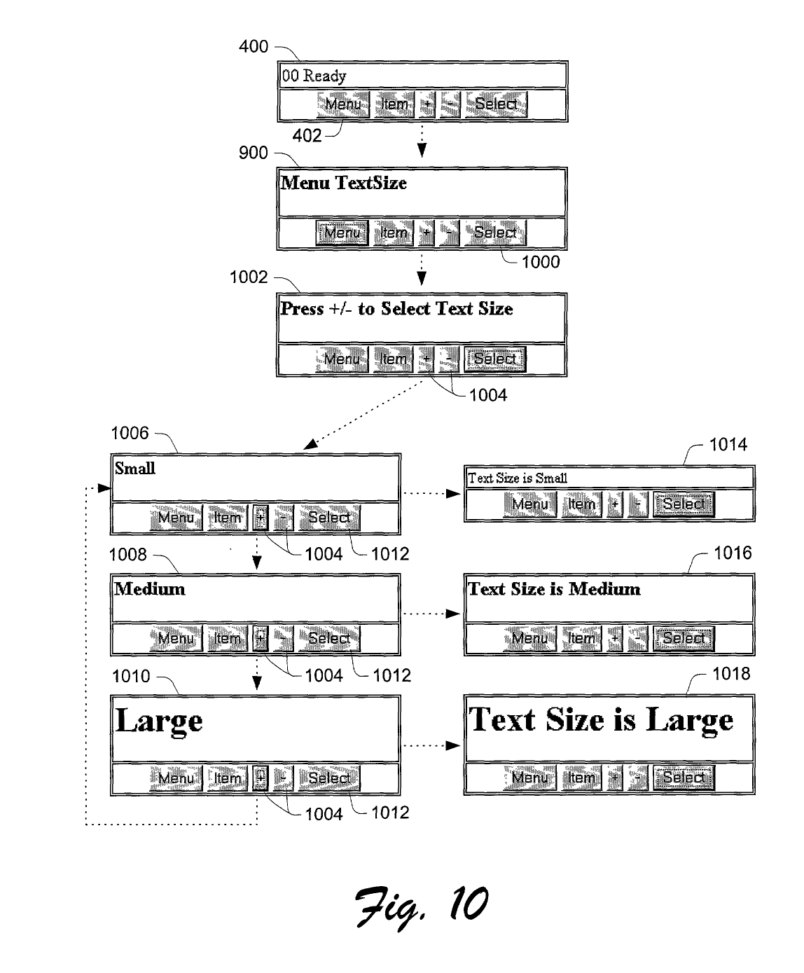

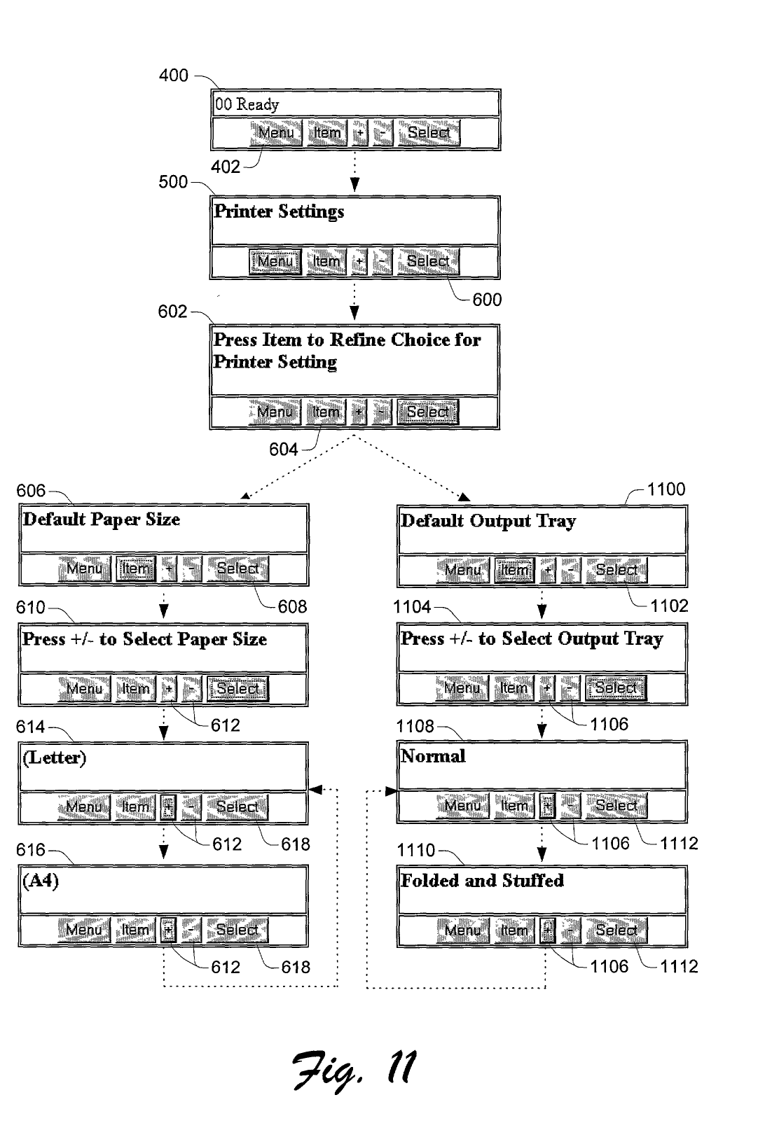

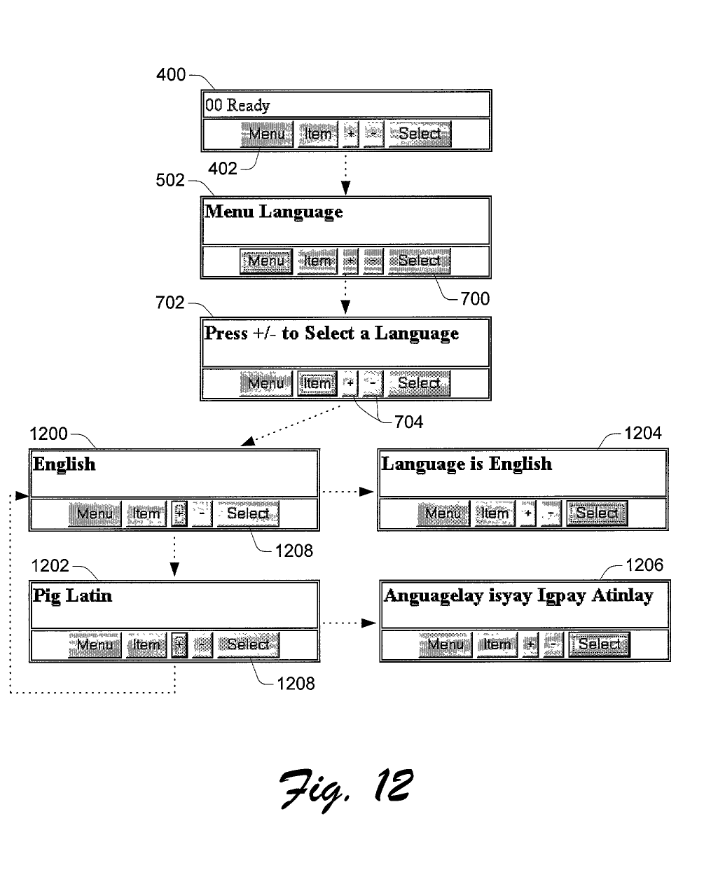

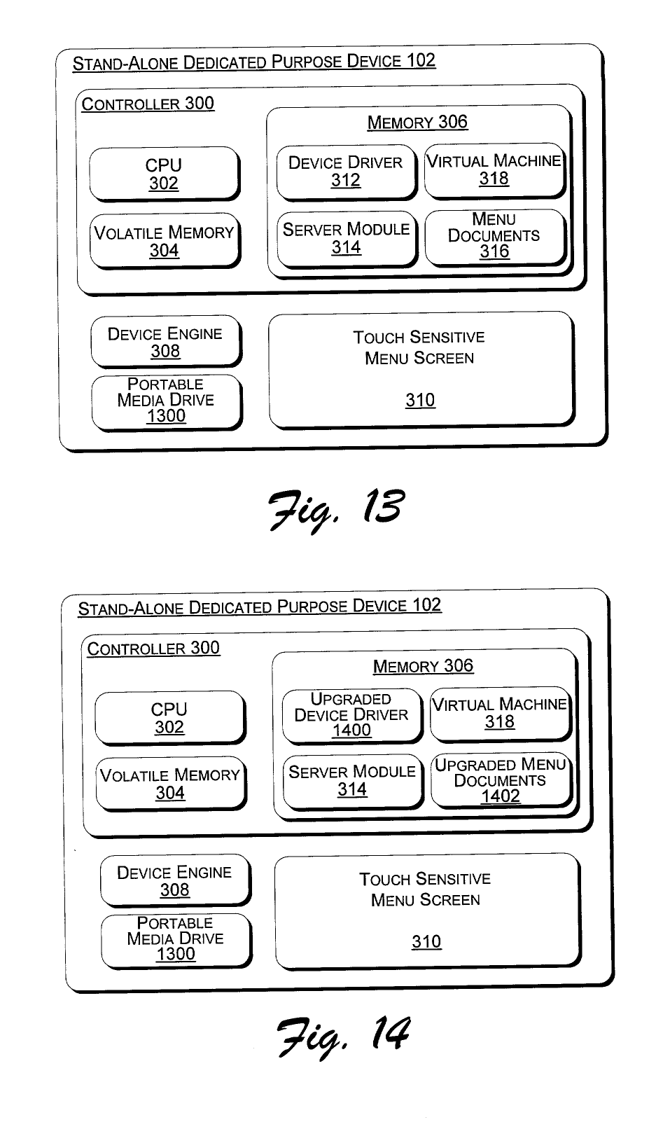

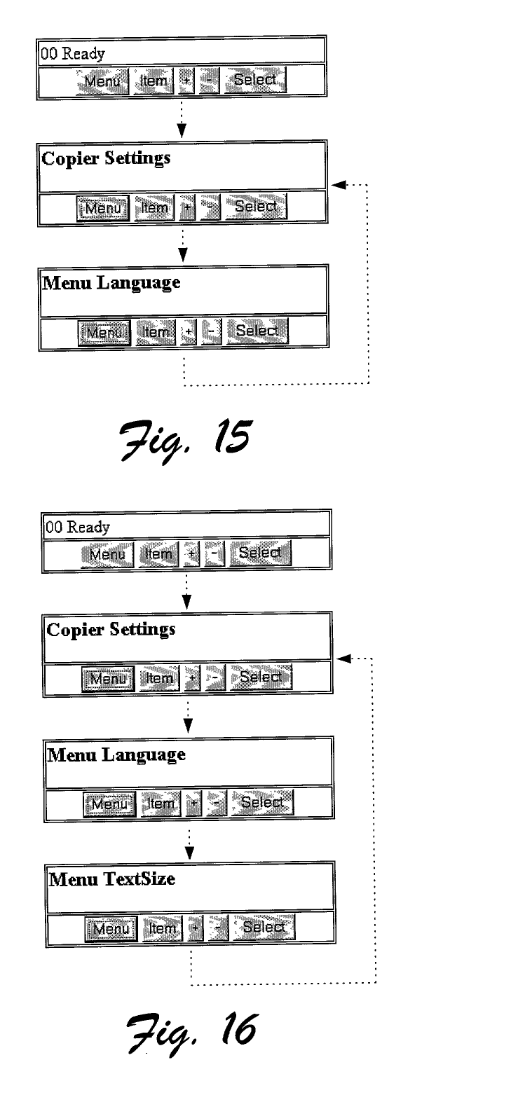

FIG. 8 illustrates an alternate embodiment of the system 100 of FIG. 1. The alternate embodiment of FIG. 8 is configured in the same way as the prior embodiment of FIG. 3 with the exception of the device driver and menu documents stored in memory 306, which have been upgraded. In the alternate embodiment, upgraded device driver 800 installed in memory 306 provides additional functionality to dedicated purpose device 102 beyond that provided by the initial device driver 312 of the previous embodiment. In addition, upgraded menu documents 802 installed in memory 306 provide a reconfigured touch sensitive menu screen 310 that accommodates the upgraded functionality of the dedicated purpose device 102. The upgraded device driver 800 and upgraded menu documents 802 preferably result from a single software package upgrade installed onto dedicated purpose device 102. Thus, a user is immediately able to access upgraded functions on the device 102 through a reconfigured touch sensitive menu screen 310 that presents menu pages consistent with all the available functions of the device 102.

The software package upgrade whose installation results in upgraded device driver 800 and upgraded menu documents 802 is preferably downloaded over network 106 onto dedicated purpose device 102 from vendor system 104. However, it may also be loaded directly onto the dedicated purpose device 102 using a portable data medium such as a floppy diskette or CD-ROM. Drives for accessing such portable data media (e.g., magnetic floppy disk drive, optical disk drive, etc.), although not illustrated, are contemplated as part of dedicated purpose devices 102 embodied in FIGS. 3 and 8. In addition, the software package upgrade may also be loaded onto dedicated purpose device 102 from host computer 108.

Like the previous embodiment of FIG. 3 where device driver 312 and menu documents 316 can be stored and executed on host computer 108, the upgraded device driver 800 and upgraded menu documents 802 can also be stored and executed on host computer 108, as illustrated by upgraded device driver 804 and upgraded menu documents 806.

The previously described embodiment of FIG. 3 and example menu pages of FIGS. 4, 5, 6 and 7 illustrate the general manner in which a touch sensitive menu screen 310 operates with menu pages driven by underlying markup language documents having embedded script code. Although the manner in which the touch sensitive menu screen 310 of FIG. 8 operates is the same as that for FIG. 3, the alternate embodiment of FIG. 8 further illustrates how a touch sensitive menu screen 310 is reconfigured to accommodate functional upgrades to the dedicated purpose device 102.

Accordingly, FIGS. 9, 10, 11 and 12 illustrate example menu pages that might be displayed on touch sensitive menu screen 310 of dedicated purpose device 102 in the alternate embodiment of FIG. 8. A comparison of the menu pages of FIGS. 9, 10, 11 and 12 with those of FIGS. 5, 6 and 7 demonstrates how a touch sensitive menu screen 310 might be reconfigured to present functional upgrades to dedicated purpose device 102.

The menu pages of FIG. 9 present basic menu items available for the dedicated purpose device 102 in the alternate embodiment of FIG. 8. The menu pages of FIG. 9 are analogous to the menu pages of FIG. 5 that present menu items available for the dedicated purpose device 102 in the prior embodiment of FIG. 3. The dedicated purpose device 102 in both examples is embodied as a printer device. Referring to FIGS. 8 and 9, the touch sensitive menu screen 310 for the example printer device 102 offers a user the choice of a “Printer Settings” item 500, a “Menu Language” item 502 and a “Menu TextSize” item 900. Repeatedly pressing the menu key 402 on a currently displayed menu page cycles the touch sensitive menu screen 310 through the available menu items as indicated by the arrows between the “Printer Settings” menu page 500, the “Menu Language” menu page 502 and the “Menu TextSize” menu page 900. The dedicated purpose device 102 and touch sensitive menu screen 310 of the alternate embodiment therefore offer a menu text size function in addition to functions offered in the prior embodiment. The upgraded device driver 804 and menu documents 806 provide upgraded functionality and a reconfigured menu screen 310 needed for its access.

The menu pages of FIG. 10 provide an example of how the touch sensitive menu screen 310 might be updated to accommodate use of the added “Menu TextSize” function from FIG. 9. Upon selecting the “Menu TextSize” menu item 900 using select key 1000, menu page 1002 is displayed, providing further instructions to the user to press the “+/−” keys 1004 to select a text size. Repeatedly pressing the “+/−” keys 1004 cycles the touch sensitive menu screen 310 through the available text sizes as indicated by the arrows between the “Small” menu page 1006, the “Medium” menu page 1008 and the “Large” menu page 1010. As discussed above, the descriptive text on the menu pages is updated by script code associated with the “+/−” keys 1004 that executes when the keys are activated. The printer setting for the “Menu TextSize” is set when the user activates one of the select keys 1012. Menu pages 1014, 1016 and 1018 indicate which text size has been selected by providing a message that states and illustrates the new text size.

In addition to providing entirely new menu item functions, the upgraded device driver 804 and menu documents 806 of FIG. 8 can also upgrade pre-existing menu items with additional functions. The menu pages of FIG. 11 demonstrate an example of an additional printer setting that might be made available through upgraded device driver 804 and upgraded menu documents 806. The operation of the touch sensitive menu screen 310 is the same as described above with respect to FIG. 6 except that the “Default Paper Size” is not the only printer setting available on the example printer device 102. Therefore, repeatedly pressing the item key 604 will cycle the touch sensitive menu screen 310 between the “Default Paper Size” menu page 606 and the “Default Output Tray” menu page 1100.

The process described above with respect to FIG. 6 for setting a “Default Paper Size” 606 with touch sensitive menu screen 310 applies in the same manner to FIG. 9 for setting a “Default Paper Size” 606 or a “Default Output Tray” 1100. Therefore, upon selecting the “Default Output Tray” 1100 setting using select key 1102, menu page 1104 is displayed, providing further instructions to the user to press the “+/−” keys 1106 to select an output tray. Repeatedly pressing the “+/−” keys 1106 cycles the touch sensitive menu screen 310 through the available output trays as indicated by the arrows between the “Normal” menu page 1108 and the “Folded and Stuffed” menu page 1110. The descriptive text on the menu pages is updated by script code associated with the “+/−” keys 1106 that executes when the keys are activated. The printer setting for the default output tray is set when the user activates one of the select keys 1112.

The menu pages of FIG. 12 demonstrate an example of an additional menu language that might be made available through upgraded device driver 804 and upgraded menu documents 806 illustrated in the alternate embodiment of FIG. 8. The ability to reconfigure the touch sensitive menu screen 310 with menu pages driven by underlying markup language documents permits localizing the language displayed on the screen 310 with a mere software upgrade. This reduces the need for more costly and time-intensive methods of updating a menu screen to a local language such as plastic key overlays and silk screen methods. The operation of the touch sensitive menu screen 310 is the same as described above with respect to FIG. 7 except that English is not the only language available on the example printer device 102. Therefore, repeatedly pressing the “+/−” keys 704 will cycle the touch sensitive menu screen 310 through the available menu languages. The touch sensitive menu screen 310 is capable of displaying any language made available by upgraded device driver 804. Thus, to the extent that market economies demand, virtually any world language may be made available as a menu language through an upgraded device driver 804. It is therefore likely that upgraded device drivers 804 will be available to support the world's more well-known languages before they are available to support the world's less-known languages. Examples of some of the world's more well-known languages include English, Chinese, Hindi, Spanish, Russian, French, Arabic, Japanese, German and Italian.

The two languages illustrated in FIG. 12 are therefore shown by way of example only, and not as a limitation. Moreover, the two languages, English 1200 and Pig Latin 1202, are provided for the reader's benefit as a way to illustrate how menu pages 1204 and 1206 might be used to confirm which language a user has selected with one of the select keys 1208.

Stand-Alone Embodiment of a Dedicated Purpose Device for Implementing a Touch Sensitive Menu Screen

FIGS. 13 and 14 illustrate stand-alone embodiments of a dedicated purpose device such as those shown in FIG. 2. The stand-alone dedicated purpose device 102 is configured mostly the same as dedicated purpose devices 102 of FIGS. 1, 3 and 8, except that it illustrates a portable media drive 1300. Because stand-alone devices 102 of FIGS. 13 and 14 are not networked like the dedicated purpose devices 102 in prior embodiments, the portable media drive 1300 is illustrated to point out a likely way of loading software onto the stand-alone devices 102. As discussed above, portable media drives are also contemplated (but not illustrated) on the dedicated purpose device 102 of FIGS. 1, 3 and 8.

Stand-alone device 102 of FIG. 13 is analogous to the dedicated purpose device 102 shown in the networked system 100 of FIGS. 1 and 3. Thus, operation of the touch sensitive menu screen 310 on stand-alone device 102 of FIG. 13 is similar to that described above regarding the dedicated purpose device 102 of FIG. 3. Therefore, the example menu pages of FIGS. 4-7 described above apply in a similar way to touch sensitive menu screen 310 on stand-alone device 102. However, because stand-alone device 102 is more typically embodied as a copier, scanner or fax machine, FIG. 15 illustrates additional example menu pages that might be displayed on the touch sensitive menu screen 310 of the stand-alone device 102 embodied as a copier.

Likewise, stand-alone device 102 of FIG. 14 is analogous to the dedicated purpose device 102 shown in the networked system 100 of FIGS. 1 and 8. That is, stand-alone device 102 of FIG. 14 includes upgraded device driver 1400 and upgraded menu documents 1402. Thus, the operation of the touch sensitive menu screen 310 on stand-alone device 102 of FIG. 14 is similar to that described above regarding the dedicated purpose device 102 of FIG. 8. Therefore, the example menu pages of FIGS. 9-12 described above apply in a similar way to touch sensitive menu screen 310 on stand-alone device 102 of FIG. 14. However, because stand-alone device 102 is more typically embodied as a copier, scanner or fax machine, FIG. 16 illustrates additional example menu pages that might be displayed on the touch sensitive menu screen 310 of the stand-alone device 102 embodied as a copier. The menu pages of FIG. 16 illustrate an additional menu item made available by the upgraded device driver 1400 and upgraded menu documents 1402.

Exemplary Methods for Implementing a Touch Sensitive Menu Screen on a Dedicated Purpose Device

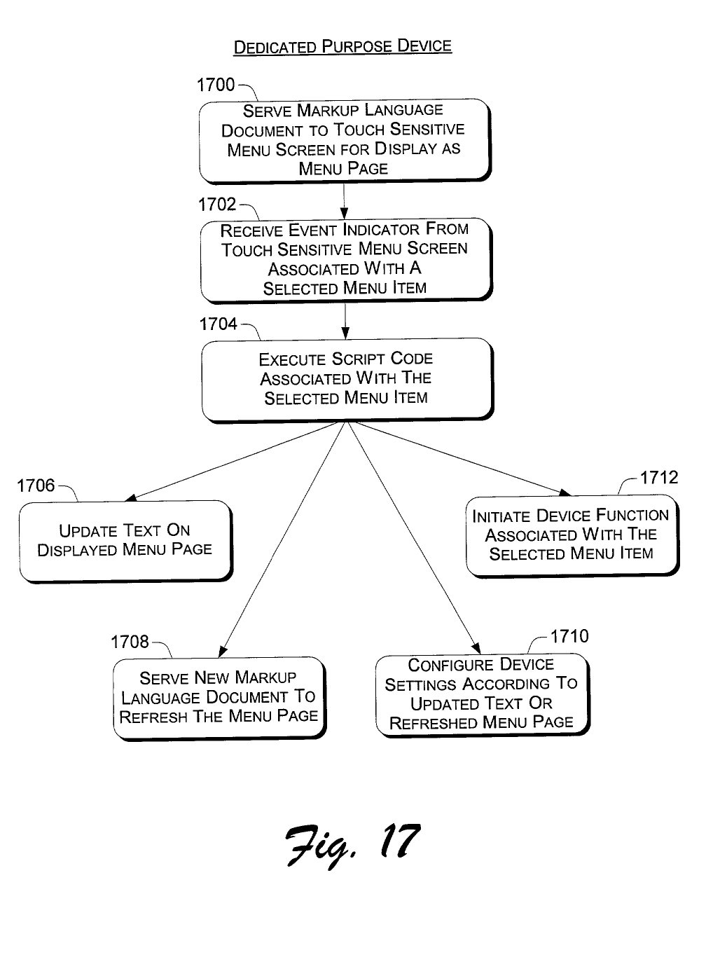

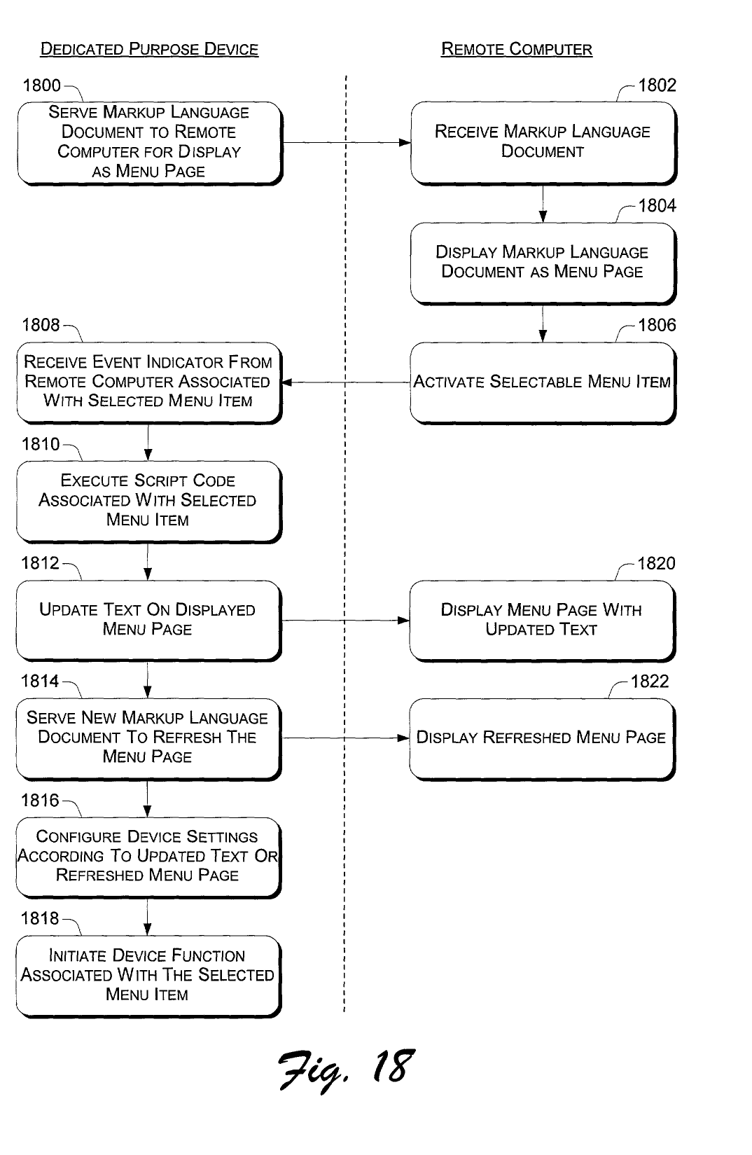

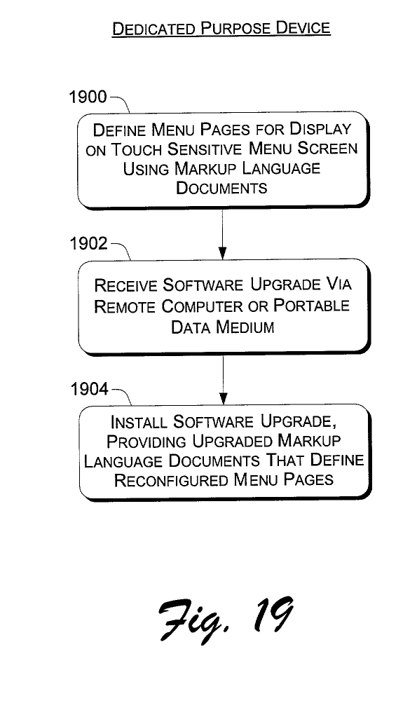

Example methods for implementing and reconfiguring a touch sensitive menu screen will now be described with primary reference to FIGS. 17 and 18. The methods apply generally to dedicated purpose devices 102 of FIGS. 1, 3, and 8 as well as stand-alone dedicated purpose devices 102 of FIGS. 2, 13, and 14.

FIG. 17 is a flow diagram that shows an example of a general method for displaying and activating a menu page on a touch sensitive menu screen 310 of a dedicated purpose device 102. At block 1700, a dedicated purpose device 102 having a touch sensitive menu screen 310 serves a markup language document to the screen 310. The markup language document defines a menu page that is displayed on the screen 310. At block 1702, the dedicated purpose device 102 receives an event indicator from the touch sensitive menu screen 310 that is associated with a menu item on the screen that has been selected by a user. In response to the event indicator, at block 1704, the dedicated purpose device 102 executes script code that is associated with the selected menu item. Blocks 1706-1712 show several of the most likely tasks that may be performed by the executing script code from block 1704. This group of tasks is provided by way of example only, and is not meant as a limitation on the tasks that might be performed by script code that executes on dedicated purpose device 102. In addition, these tasks are generally performed in various combinations with one another. For example, configuring the internal device settings (at block 1710) should occur along with updating text on the displayed menu page (at block 1706), but a device function (at block 1712) (such as printing or copying) is not necessarily initiated each time a menu item is selected.

FIG. 18 is a flow diagram that shows an example of a general method for displaying and activating a menu page of a dedicated purpose device 102 on a remote computer such as computer 108. The method shown by the flow diagram of FIG. 18 is generally the same as that shown by the flow diagram of FIG. 17, except that the remote computer acts as the user interface rather than the touch sensitive menu screen 310. Under this scenario, although it is preferable that the dedicated purpose device 102 include a touch sensitive menu screen 310 capable of rendering markup language documents as menu pages, it is not required.

At block 1800, a dedicated purpose device 102 serves a markup language document to a remote computer. The markup language document defines a menu page of the dedicated purpose device 102 that is displayed on the remote computer. The dedicated purpose device 102 may be directly coupled to the remote computer or it may be coupled through a network such as network 106 of FIG. 1. At block 1802, the remote computer receives the markup language document, and at block 1804 the remote computer displays the document as a menu page. The markup language document is preferably interpreted and rendered by a browser application executing on the remote computer. At block 1806, a user activates a selectable menu item presented by the menu page. A menu item can be activated or selected using an input device of the remote computer, such as a mouse. At block 1808, the dedicated purpose device 102 receives an event indicator that indicates which menu item has been selected. At block 1808, script code associated with the selected menu item is executed.

Blocks 1812-1818 are analogous to blocks 1706-1712 of FIG. 17. Thus, blocks 1812-1818 show several of the most likely tasks that may be performed by the executing script code from block 1810. Block 1812 shows the dedicated purpose device 102 updating text on the displayed menu page, and block 1820 shows the updated text being displayed on the remote computer. Similarly, block 1814 shows the dedicated purpose device 102 serving a new markup language document to refresh the menu page, and block 1822 shows the refreshed menu page being displayed on the remote computer. As discussed above regarding blocks 1706-1712 of FIG. 17, the tasks of blocks 1812-1818 are generally performed in various combinations with one another.

FIG. 19 is a flow diagram illustrating an example method of reconfiguring a touch sensitive menu screen 310 of a dedicated purpose device to accommodate a functional upgrade to the dedicated purpose device 102. At block 1900, menu pages to be displayed on the touch sensitive menu screen 310 of the dedicated purpose device 102 are defined by markup language documents. The documents are stored in memory on the device 102. At block 1902, the dedicated purpose device 102 receives a software upgrade. The software upgrade is most likely downloaded over a network 106 from a remote computer. However, the software upgrade may also be loaded onto dedicated purpose device 102 from a portable data medium. If the dedicated purpose device 102 is a stand-alone dedicated purpose device 102 such as that illustrated in FIG. 2, the software upgrade will be loaded onto dedicated purpose device 102 from a portable data medium. At block 1904, the software upgrade is installed onto dedicated purpose device 102, creating a set of upgraded markup language documents on the device 102. It is preferable, but not necessary, that the software upgrade also provide the functional upgrade of dedicated purpose device 102 to which the upgraded markup language documents apply. The upgraded markup language documents define reconfigured menu pages to be displayed on the touch sensitive menu screen 310. The reconfigured menu pages present the various functions of dedicated purpose device 102, including the upgraded function. Thus, a single software upgrade can upgrade the functionality of device 102 in addition to upgrading the touch sensitive menu screen 310 through which that functionality can be immediately accessed.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A dedicated purpose device comprising:
a touch sensitive menu screen to present menu pages having one or more selectable menu items; and
markup language documents that define the menu pages.

2. A dedicated purpose device as recited in claim 1, further comprising:
a virtual machine executing on the dedicated purpose device to interpret and execute script code associated with a selected menu item.

3. A dedicated purpose device as recited in claim 2, wherein the script code is configured to initiate a function of the dedicated purpose device.

4. A dedicated purpose device as recited in claim 2, wherein the script code is configured to alter text displayed on a menu page and reconfigure internal settings of the device corresponding to the altered text.

5. A dedicated purpose device as recited in claim 2, wherein the script code is configured to update the touch sensitive menu screen with a new menu page and reconfigure internal settings of the device corresponding to the new menu page.

6. A dedicated purpose device as recited in claim 2, wherein the script code is javascript code and the virtual machine is a java virtual machine.

7. A dedicated purpose device as recited in claim 1, further comprising:
a local server module configured to serve a markup language document to the touch sensitive menu screen.

8. A dedicated purpose device as recited in claim 7, wherein the local server module is further configured to serve a markup language document to a remote computer.

9. A dedicated purpose device as recited in claim 1 embodied as a device selected from a group of devices comprising:
a printer;
a copier;
a scanner;
a facsimile machine; and
a multifunction peripheral device.

10. A dedicated purpose device as recited in claim 1, wherein a selectable menu item is defined by a markup language document and comprises a graphical key with a textual label.

11. A dedicated purpose device as recited in claim 1, wherein the menu pages identify and permit access to operable functions of the device.

12. A dedicated purpose device as recited in claim 11, wherein the various menu pages are reconfigurable to identify and permit access to upgraded and additional operable functions of the device.

13. On a dedicated purpose device having a touch sensitive menu screen, a method comprising:
serving a markup language document for display as a menu page on the touch sensitive menu screen, the menu page having selectable menu items; and
executing script code associated with a selected menu item.

14. A method as recited in claim 13, further comprising:
in response to executing the script code, updating text displayed on the menu page.

15. A method as recited in claim 13, further comprising:
in response to executing the script code, serving a new markup language document to the touch sensitive menu screen for display as a refreshed menu page.

16. A method as recited in claim 13, further comprising:
in response to executing the script code, initiating a function of the dedicated purpose device.

17. A method as recited in claim 13, further comprising:
upgrading the dedicated purpose device with a new function; and
serving a markup language document for display as an upgraded menu page on the touch sensitive menu screen, the upgraded menu page having selectable menu items that correspond to the new function.

18. On a computer coupled to a dedicated purpose device, a method comprising:
receiving a markup language document from the dedicated purpose device;
displaying the markup language document as a menu page of the dedicated purpose device;
activating a menu item on the menu page;
in response to the activating, receiving an updated markup language document from the dedicated purpose device.

19. The method as recited in claim 18, wherein displaying the markup language document further comprises interpreting the markup language document with a browser application.

20. The method as recited in claim 18, wherein activating a menu item further comprises selecting the menu item with an input device of the computer.

21. The method as recited in claim 18, wherein activating a menu item initiates a function of the dedicated purpose device.

22. On a dedicated purpose device having a touch sensitive menu screen, a method comprising:
defining menu pages for display on the touch sensitive menu screen with markup language documents; and
installing upgraded markup language documents that define reconfigured menu pages for display on the touch sensitive menu screen.

23. The method as recited in claim 22, wherein the menu pages present initial functions of the dedicated purpose device and the reconfigured menu pages present upgraded functions of the dedicated purpose device.

24. The method as recited in claim 23, wherein the upgraded functions include the initial functions and later-installed functions.

25. The method as recited in claim 22, wherein installing upgraded markup language documents comprises:
receiving a software upgrade; and
installing the software upgrade on the dedicated purpose device.

26. The method as recited in claim 25, wherein receiving a software upgrade comprises loading the software upgrade onto the dedicated purpose device from a remote computer.

27. The method as recited in claim 25, wherein receiving a software upgrade comprises loading the software upgrade onto the dedicated purpose device from a portable data medium.

28. On a dedicated purpose device, a method comprising:
serving a markup language document to a remote computer for display as a menu page, the menu page having selectable menu items;
receiving an event indicator associated with a selected menu item; and
executing a script code associated with the selected menu item.

29. The method as recited in claim 28, wherein executing a script code further comprises:
altering text associated with the selectable menu items.

30. The method as recited in claim 28, wherein executing a script code further comprises:
serving a new markup language document to the remote computer for display as a refreshed menu page on the computer.

31. The method as recited in claim 28, wherein executing a script code further comprises:
initiating a function of the dedicated purpose device.

32. On a dedicated purpose device having a touch sensitive menu screen, a method comprising:
serving a markup language document for display as a menu page on the touch sensitive menu screen, the menu page having selectable menu items;
receiving an event indicator associated with a selected menu item; and
executing a script code associated with the selected menu item.

33. The method as recited in claim 32, wherein executing a script code further comprises:
altering text associated with the selectable menu items.

34. The method as recited in claim 32, wherein executing a script code further comprises:
serving a new markup language document for display as a refreshed menu page on the touch sensitive menu screen.

35. The method as recited in claim 32, wherein executing a script code further comprises:
initiating a function of the dedicated purpose device.
